(19) United States
(12) Patent Application Publication
(10) Pub. No.: US 2026/0319515 A1
(43) Pub. Date: Oct. 15, 2026

(54) APPROXIMATION ALGORITHM FOR MINIMUM-LENGTH COVERAGE OF ARBITRARY GRID ENVIRONMENTS

(71) Applicant: Avidbots Corp, Kitchener (CA)

(72) Inventors: Megnath RAMESH, Waterloo (CA); Francis Christopher IMESON, Waterloo (CA); Stephen SMITH, Kitchener (CA); Baris FIDAN, Kitchener (CA)

(21) Appl. No.: 19/465,780

(22) Filed: Jan. 30, 2026

Related U.S. Application Data
(60) Provisional application No. 63/766,498, filed on Mar. 4, 2025.

(51) Int. Cl. G05D 1/644; A47L 11/40; G05D 1/246; G05D 1/622; G05D 105/10; G05D 109/10

(52) U.S. Cl. CPC G05D 1/644; A47L 11/4011; A47L 11/4061; G05D 1/2464; G05D 1/622; A47L 2201/04; G05D 2105/10; G05D 2109/10

(57) ABSTRACT

A computer-implemented coverage planning technique for grid environments computes axis-parallel ranks of free cells, pairs rank endpoints using a minimum-length perfect matching over collision-free transitions to form multiple closed sub-tours, and merges adjacent sub-tours into a single closed coverage path using merge operations that limit added path length. Merge operations include bounded double-edge merges and corner-junction edge swaps that can add zero or bounded additional length. A lazy evaluation strategy accelerates matching by iteratively validating and replacing only matched edges. The resulting coverage path achieves a provable approximation bound on path length and may reduce turns as a secondary objective.

### CROSS-REFERENCE TO RELATED APPLICATIONS

This application claims the benefit of and priority to U.S. Provisional Patent Application No. 63/766,498, filed Mar. 4, 2025, entitled “APPROXIMATION ALGORITHM FOR MINIMUM-LENGTH COVERAGE OF ARBITRARY GRID ENVIRONMENTS,” the entire contents of which are incorporated by reference herein.

### BACKGROUND

This disclosure relates to robotic coverage path planning. More particularly, it relates to generating minimum-length coverage paths in grid-decomposed environments, including environments with obstacles or holes, with provable approximation guarantees and with turn minimization as a secondary objective.

Autonomous and semi-autonomous mobile robots are widely used for tasks such as cleaning, sensing, inspection, agriculture, and exploration. A common problem is coverage path planning, i.e., planning a robot motion path that causes a coverage tool footprint (e.g., vacuum, scrubber, sensor footprint, seeding tool) to cover a target region.

Robotic coverage tasks (e.g., cleaning, surveying, seeding, inspection) often require a robot to traverse a region so that a coverage tool footprint sweeps substantially all target areas. Offline coverage path planning can be preferred when the environment is known and the resulting plan must be verified before execution. However, minimum-length coverage planning in general environments is computationally hard, and many practical approaches therefore rely on decompositions and heuristics that provide no explicit bound on the resulting path length.

One common framework for grid environments partitions the free space into non-overlapping straight coverage lines (also referred to as ranks) and then computes a tour that connects the coverage lines. While such line-touring or rank-touring approaches can reduce turns, they can produce paths that are longer than optimal and do not necessarily provide a tight, explicit approximation factor in practice.

### SUMMARY

Described herein are systems and methods for generating minimum-length coverage paths for connected grid environments, including environments with holes, with provable approximation guarantees. The approach begins by computing a rank partition of the grid environment into axis-parallel ranks (straight sweep segments). Endpoints of the ranks are then connected by computing a minimum-length perfect matching on a transition graph of feasible collision-free paths between endpoints. The combination of ranks and matching edges forms one or more closed sub-tours that collectively cover the environment.

The sub-tours are then merged into a single closed coverage tour using a merge ordering derived from an adjacency graph of sub-tours (e.g., via a spanning tree such as a minimum spanning tree). For merging, the system selects, for each adjacent sub-tour pair, a merge operation that limits added length, including (i) a double-edge merge across adjacent cells, and / or (ii) a corner-junction merge that swaps edges at a four-cell corner junction and can add zero or bounded additional length. In some embodiments, the ordering is additionally optimized to reduce turns added by merges, while maintaining the length guarantee.

In further embodiments, a lazy evaluation strategy accelerates computation of the perfect matching by starting with a dense graph of Euclidean edges and iteratively replacing only those matched edges that are invalid or collide with obstacles with corresponding collision-free paths, until the matching contains only valid edges.

### BRIEF DESCRIPTION OF THE DRAWINGS

FIG. 1 illustrates an example environment where a rank-touring solution can have length 5/3 times an optimal coverage path.

FIG. 2 is a flow diagram and/or schematic depicting stages of an example coverage planning method (MLC-Approx).

FIG. 3 illustrates sub-tour merging using a spanning tree ordering of sub-tours.

FIG. 4 illustrates corner-junction merging using edge swaps, including an example sub-tour modification to enable a merge.

FIG. 5 illustrates comparative path length results across multiple maps and methods.

FIG. 6 illustrates example coverage paths generated by different approaches for an example environment.

FIG. 7 illustrates comparative turn metrics (e.g., turns per path length) across multiple approaches.

FIG. 8 illustrates runtime comparisons and the benefit of lazy evaluations.

### DETAILED DESCRIPTION

### Definitions

Grid environment. A representation of a two-dimensional workspace as a set of square grid cells, including free cells to be covered and obstacle cells to be avoided.

Cell. A grid element having a width substantially equal to a coverage tool width or a planning resolution.

Rank. A maximal or selected set of contiguous free cells aligned along a horizontal or vertical line that can be covered by a straight-line sweep of the coverage tool.

Coverage line. A straight-line path segment associated with a rank, typically connecting centers of end cells of the rank.

Rank endpoints. Terminal points of a coverage line corresponding to end cells of the rank.

Transition path. A collision-free path between two rank endpoints, potentially computed on the grid or in continuous space.

Sub-tour. A closed path formed by combining ranks (coverage lines) and selected transition paths (e.g., perfect matching edges).

Adjacent sub-tours. Two sub-tours that cover grid cells that are axis-parallel neighbors (share an edge) and/or that meet at a corner junction.

### Overview of Coverage Planning in a Grid Representation

A workspace may be represented as an integral orthogonal polygon approximation on a grid. A robot carrying a coverage tool (e.g., a square footprint of width l) is tasked with producing a closed path that sweeps substantially all free cells in the grid while avoiding obstacles. The primary optimization objective is path length, and a secondary objective is to reduce turns (e.g., to improve execution time and coverage quality).

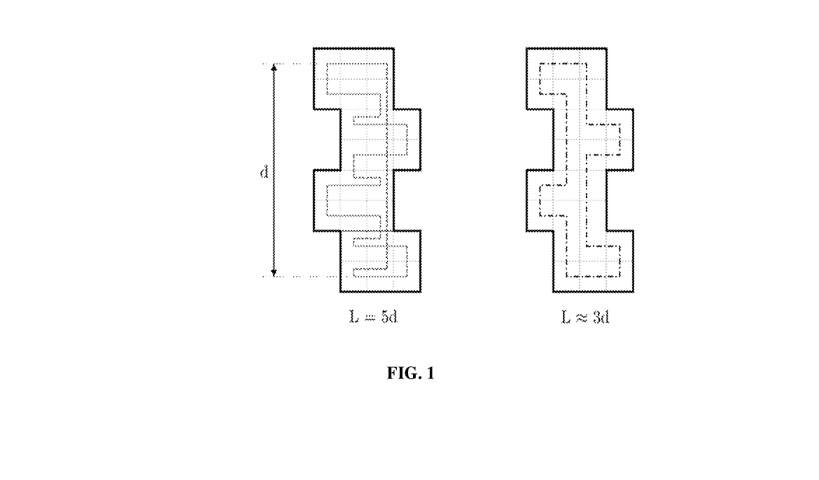

FIG. 1 illustrates an example environment where a rank-touring solution can have length 5/3 times an optimal coverage path. According to FIG. 1, an example environment is shown where the ranks induce a coverage tour with length 5/3 times the length of the optimal coverage path.

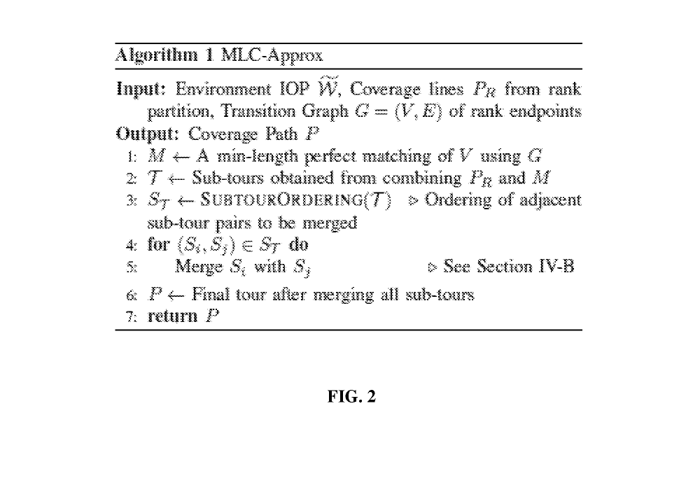

FIG. 2 is a flow diagram or schematic depicting stages of an example coverage planning method (MLC-Approx).

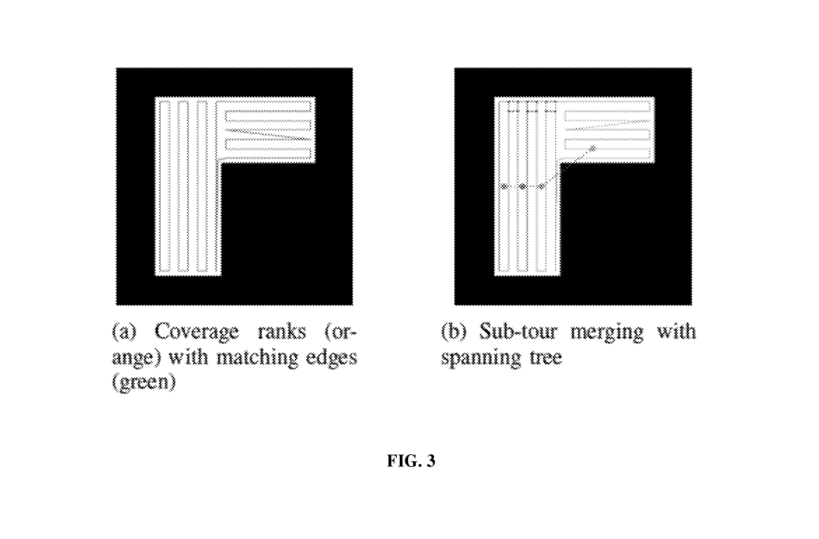

FIG. 3 illustrates sub-tour merging using a spanning tree ordering of sub-tours. According to FIG. 3 MLC-Approx stages is shown whereby FIG. 3(a) obtain coverage lines (orange) from the minimum rank partition and compute min-length perfect matching paths (green), and FIG. 3(b) identify the resulting sub-tours (colored paths) and evaluate possible merges (black lines) as determined by an ordering (dotted green lines).

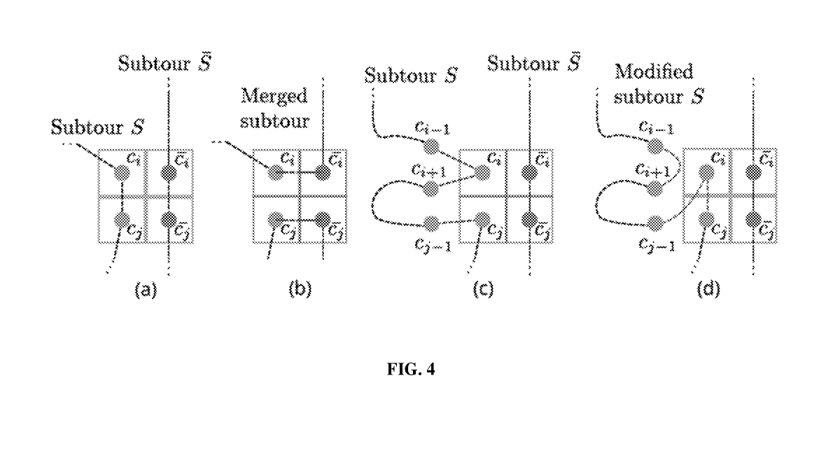

FIG. 4 illustrates corner-junction merging using edge swaps, including an example sub-tour modification to enable a merge. According to FIG. 4, corner junction embodiment merging is shown whereby FIG. 4(a) shows corner junction formed by 4 grid cells, FIG. 4(b) shows edge swap to merge two sub-tours at the junction and FIGS. 4(c) and 4(d) shows modifying sub-tour S to allow an edge swap by removing the red edges and adding the green edges.

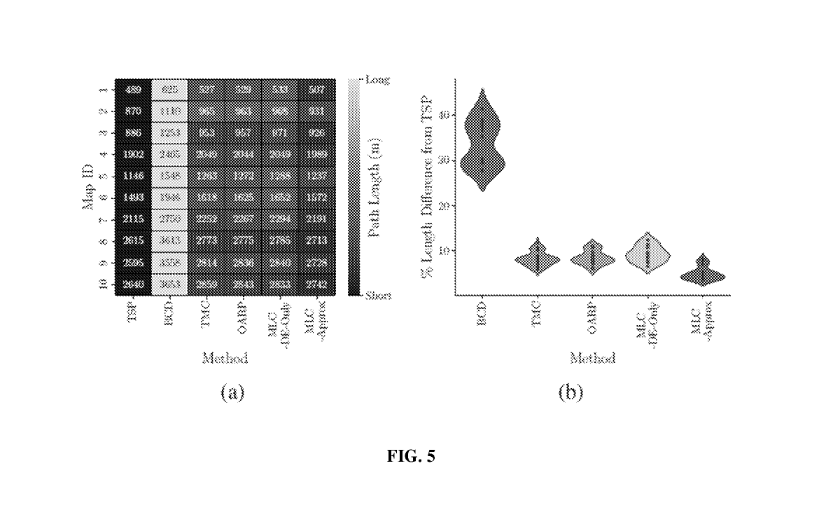

FIG. 5 illustrates comparative path length results across multiple maps and methods. According to FIG. 5, path length comparisons is shown whereby FIG. 5(a) shows average path lengths for each map and FIG. 5(b) shows % length difference from TSP across all maps.

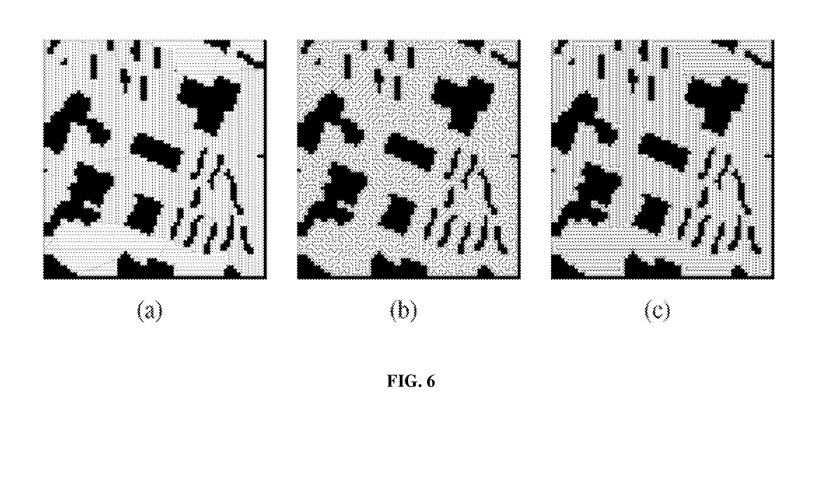

FIG. 6 illustrates example coverage paths generated by different approaches for an example environment. According to FIG. 6, coverage paths for an example environment is shown generated using OARP (FIG. 6(a)), TSP FIG. 6(b), and the proposed MLC-Approx (FIG. 6(c)).

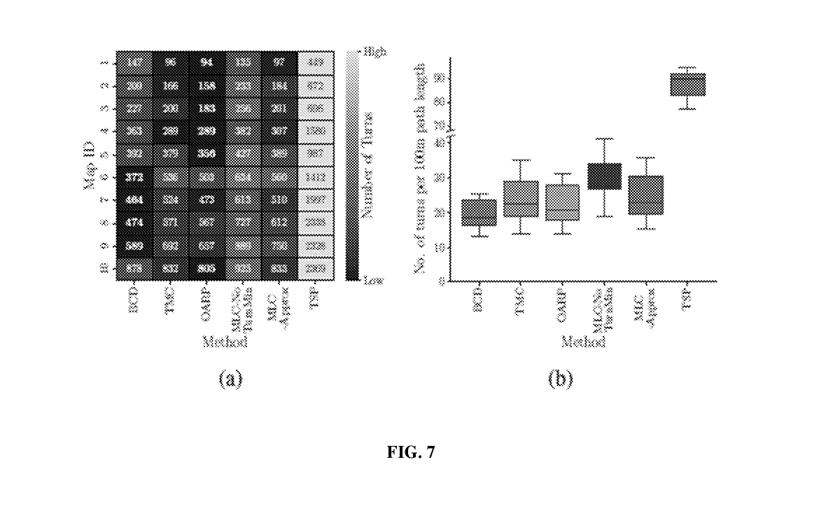

FIG. 7 illustrates comparative turn metrics (e.g., turns per path length) across multiple approaches. According to FIG. 7, turn comparisons are shown, whereby FIG. 7(a) illustrates number of turns (bold - fewest turns) and FIG. 7(b) illustrates coverage path straightness as denoted by the number of turns per 100 meters of path length.

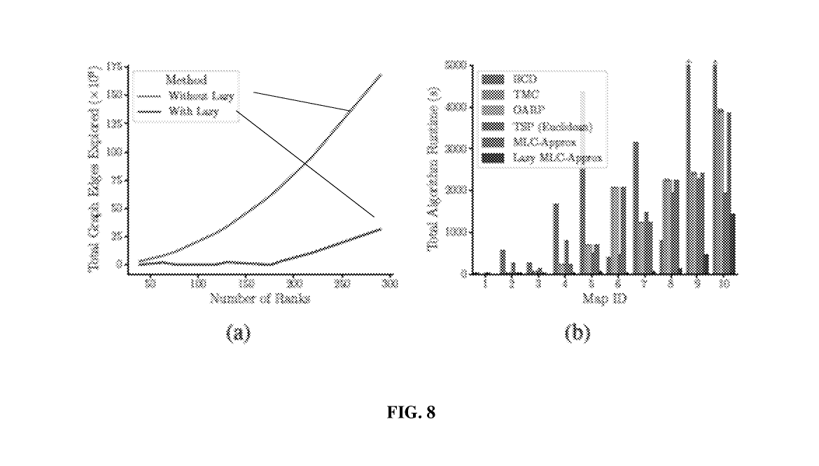

FIG. 8 illustrates runtime comparisons and the benefit of lazy evaluations. According to FIG. 8, runtime comparisons are shown whereby FIG. 8(a) illustrates the number of edge evaluations (i.e., obstacle-free paths planned) by MLC-Approx with / without lazy evaluation and FIG. 8(b) illustrates runtimes for each map (red arrow - exceeds 5000s).

### Rank Partitioning

The free cells are partitioned into a set of non-overlapping axis-parallel ranks. In some embodiments, the partition is chosen to minimize the number of ranks. Each rank corresponds to a coverage line that can be executed as a straight sweep by the robot. The collection of coverage lines provides complete cell coverage when combined with appropriate transitions.

### Transition Graph and Minimum-Length Perfect Matching

Let V be the set of rank endpoints. A transition graph G=(V,E) is formed where each edge represents a feasible collision-free transition path between a pair of endpoints, and each edge weight represents transition length (or a cost derived from length). A minimum-length perfect matching is computed on this graph to connect endpoints in pairs with minimum total cost. When the matching edges are added to the coverage lines, one or more closed sub-tours are produced that collectively cover all ranks.

### Sub-tour Adjacency and Merge Ordering

To combine the sub-tours into a single closed coverage tour, an adjacency graph G' is constructed over the sub-tours. Vertices represent sub-tours and an edge is added between two vertices when the corresponding sub-tours are adjacent. An ordering of merges is determined from a spanning structure of G', such as a spanning tree. In some embodiments, edge weights represent estimated turns added by merging and a minimum spanning tree is selected to reduce added turns.

### Sub-tour Merge Operations

For each selected adjacent sub-tour pair, one or more candidate merge operations are evaluated and the merge operation with the least added length (and optionally least added turns) is applied.

### Double-Edge Merge

If a cell c in a first sub-tour is adjacent (shares an edge) with a cell c̄ in a second sub-tour, a merge may be performed by adding a traversal from c to c̄ and a return traversal from c̄ back to c. This effectively stitches the two sub-tours together while adding a bounded length (e.g., approximately 2l in a grid of cell width l).

### Corner-Junction Merge

If two adjacent cells in a first sub-tour share a corner with two adjacent cells in a second sub-tour (a four-cell corner junction), an edge swap may be used to merge the sub-tours. When each sub-tour contains an edge along the two-by-two corner junction that is parallel and adjacent, the merge can be implemented as an edge swap that adds zero length. If the needed edge is not present in a sub-tour, the sub-tour may be locally modified by swapping a small number of edges to create a junction edge, after which the merge is performed. The local modification is selected to bound any added length, and if a bound cannot be met, the system may revert to the double-edge merge.

### Lazy Evaluation for Efficient Matching

In some embodiments, constructing all collision-free transition paths between endpoint pairs is computationally expensive. A lazy strategy may be used in which an initial dense graph uses Euclidean distances (or other optimistic lower bounds) as edge weights. A perfect matching is computed on this graph, which may include invalid edges. Only the edges that appear in the current matching are then validated and, if invalid, replaced with computed collision-free paths and updated weights. The matching is recomputed and the process repeats until the matching contains only valid edges. This reduces the number of collision-free path computations in practice while preserving optimality of the resulting matching under the chosen cost function.

### Example Approximation Guarantees

In some embodiments, the described approach achieves an approximation factor on total path length that is bounded relative to an optimal coverage tour for the grid environment. For example, for a connected grid environment having n free cells and a rank partition with m ranks, a constructed tour can be bounded by a factor of approximately (1.5 + m/n) of the optimal tour, where m/n is typically small when the number of ranks is minimized.

### Implementation Examples

The methods may be implemented on a mobile robot, an autonomous cleaning robot, an aerial vehicle, or any computing system that generates coverage routes for execution by a robot. The system may include one or more processors, memory, and program instructions that cause performance of the operations described herein, including grid generation, rank partitioning, graph construction, matching, merge selection, and output of a coverage plan.

More information on embodiments of this disclosure can be found in IEEE academic publication by Ramesh et al., entitled “Minimum-Length Coverage Path Planning for Grid Environments with Approximation Guarantees” in IEEE Robotics and Automation Letters, vol. 10, no. 10, pp. 10674-10681, Oct. 2025, which is herein incorporated by reference in its entirety.

According to the disclosure, a computer-implemented method for generating a coverage path for a robot in a grid environment. The method comprises the steps of computing, by one or more processors, a rank partition of free cells of the grid environment into a plurality of axis-parallel ranks, each rank comprising contiguous free cells coverable by a straight-line sweep of a coverage tool, generating a set of coverage lines, each coverage line corresponding to a respective rank and spanning endpoints of the respective rank, forming a transition graph whose vertices comprise endpoints of the coverage lines and whose edges comprise feasible collision-free transition paths between endpoints with associated edge costs, computing, on the transition graph, a minimum-length perfect matching that pairs endpoints of the coverage lines, combining the coverage lines and the minimum-length perfect matching to form a plurality of closed sub-tours that collectively cover the free cells, and merging the plurality of closed sub-tours into a single closed coverage tour by repeatedly applying, for selected adjacent sub-tour pairs, a merge operation chosen to limit added path length.

According to the disclosure, computing the rank partition of the method comprises computing a minimum-rank partition that minimizes a number of ranks among axis-parallel rank partitions of the free cells. The selected adjacent sub-tour pairs of the method are determined by constructing a sub-tour adjacency graph in which vertices represent sub-tours and edges connect adjacent sub-tours, and selecting edges of a spanning tree of the sub-tour adjacency graph.

According to the disclosure, the sub-tour adjacency graph of the method comprises edge weights representing an estimated number of turns added by merging the corresponding adjacent sub-tours, and wherein the spanning tree is a minimum spanning tree that reduces the estimated number of added turns. The merge operation of the method comprises a double-edge merge that adds a traversal from a cell covered by a first sub-tour to an adjacent cell covered by a second sub-tour and adds a return traversal from the adjacent cell to the cell.

According to the disclosure, the merge operation of the method comprises a corner-junction merge at a corner junction formed by four cells including two adjacent cells covered by a first sub-tour that share a corner with two adjacent cells covered by a second sub-tour, the corner-junction merge comprising performing an edge swap that replaces two edges in the sub-tours with two cross edges that connect the sub-tours.

According to the disclosure, when a required junction edge is absent from at least one of the sub-tours, modifying the at least one sub-tour by removing a first set of edges and adding a second set of edges to create the required junction edge, and thereafter performing the edge swap. Furthermore, the modifying is selected based on a length bound for an added cross path and, when the length bound is not satisfied, the merge operation is instead performed as a double-edge merge.

According to the disclosure, the method, further comprises selecting, among a plurality of candidate merge locations between a first sub-tour and a second sub-tour, a location that minimizes added turns subject to limiting added length.

According to the disclosure, the grid environment of the method is connected and includes at least one obstacle or hole, and wherein the coverage tool has a footprint width approximately equal to a grid cell width. The transition graph edge costs of the method satisfy a triangle inequality.

According to the disclosure, computing the minimum-length perfect matching of the method comprises a lazy evaluation process including the steps of initializing a dense endpoint graph with edges weighted by Euclidean distances between endpoints, computing a candidate perfect matching on the dense endpoint graph, for each edge in the candidate perfect matching, determining whether the corresponding Euclidean edge is collision-free, and replacing each Euclidean edge that is not collision-free with a computed collision-free path edge having an updated edge cost and recomputing the candidate perfect matching until the candidate perfect matching contains only collision-free path edges.

According to the disclosure, the single closed coverage tour of the method has a total length that is bounded by an approximation factor relative to an optimal coverage tour for the free cells.

According to the disclosure, a robotic coverage planning system comprises a mobile robot comprising a drive system and a coverage tool and one or more processors coupled to memory and configured to execute instructions that cause the system to determine ranks covering a connected set of free-space cells of a grid representation of an environment, compute a minimum-length perfect matching among rank endpoints using collision-free transition costs, form subtours from the ranks and matched transitions, merge adjacent subtours into a single coverage path using at least one of (i) a double-edge merge between neighboring cells and (ii) a corner-junction edge-swap merge and command the mobile robot to traverse the coverage path.

According to the disclosure, the processors are configured to select a spanning tree of a subtour adjacency graph to order merges. The processors are also configured to compute a minimum spanning tree weighted by turns added by candidate merges.

According to the disclosure, the processors are configured to select the corner-junction edge-swap merge when it adds no additional path length beyond reuse of rank segments. The processors are configured to modify a subtour to induce an edge at a corner junction prior to performing the edge-swap merge.

According to the disclosure, the processors are configured to apply a length threshold such that merges predicted to add more than about 2l length are performed using the double-edge merge. The processors are also configured to perform lazy evaluation of collision-free transition costs by initially using lower-bound costs and computing collision-free paths for only edges appearing in an intermediate matching.

According to the disclosure, the processors iteratively update costs for edges in the intermediate matching until the matching comprises collision-free edges. The mobile robot of the system is a scrubber-dryer robot. The grid representation comprises square cells whose width corresponds to a tool width.

According to the disclosure, a coverage planning system comprises one or more processors and one or more memories storing instructions that, when executed by the one or more processors, cause the system to perform the method as mentioned above. Furthermore, a non-transitory computer-readable medium storing instructions that, when executed by one or more processors cause performance of the method of above.

According to the disclosure, a computer-implemented method for generating a coverage path for a mobile robot is disclosed. The method comprising the steps of obtaining a grid representation of an environment comprising free-space cells and obstacle cells, wherein the free-space cells form a connected region and each cell corresponds to a tool footprint width, determining a set of non-overlapping straight-line ranks that collectively cover the free-space cells, each rank comprising a sequence of adjacent cells traversable along a first axis direction or a second axis direction, identifying endpoints of the ranks; determining, for pairs of endpoints, collision-free transition path lengths through the free-space cells, computing a minimum-length perfect matching over the endpoints using the collision-free transition path lengths as edge costs to obtain matched endpoint pairs, forming a set of subtours that collectively cover the free-space cells by combining (i) rank traversals and (ii) transition traversals corresponding to the matched endpoint pairs, constructing a subtour adjacency graph indicating adjacency between subtours that cover cells that are neighbors in the grid representation, selecting a spanning tree over the subtour adjacency graph and determining an order of subtour merges based on traversing the spanning tree,

iteratively merging subtours in accordance with the order, including performing at least one merge operation selected from, adding a double-edge traversal between a first cell of a first subtour and a neighboring second cell of a second subtour, and performing a corner-junction merge comprising an edge swap between parallel edges of the first subtour and the second subtour at a corner junction of four cells, and outputting a coverage path for the mobile robot that covers the free-space cells.

According to the disclosure, determining the set of ranks of the method comprises selecting a minimum-cardinality rank partition that minimizes a number of ranks. Each cell of the method has width l and the double-edge traversal adds a path length no greater than about 21.

According to the disclosure, the corner-junction merge of the method is selected when a predicted added length for the merge is less than a threshold, and wherein the method otherwise selects the double-edge traversal. Performing the corner-junction merge of the method further comprises modifying at least one subtour by removing edges of the subtour and adding substitute edges to induce a required edge at the corner junction.

According to the disclosure, modifying the subtour of the method comprises removing edges connecting a first junction cell to its predecessor and successor in the subtour and removing an edge connecting a second junction cell to its predecessor in the subtour and adding an edge between the predecessor and successor of the first junction cell, adding an edge between the predecessor of the second junction cell and the first junction cell, and adding an edge between the first junction cell and the second junction cell.

According to the disclosure, selecting the spanning tree of the method comprises weighting adjacency edges based on an estimate of turns added by candidate merges and selecting a minimum spanning tree. Furthermore, the method further comprises minimizing turns as a secondary objective by selecting, for a given pair of adjacent subtours, a merge operation that yields a minimum number of added turns among available merge operations.

According to the disclosure, the collision-free transition path lengths of the method are determined using a visibility graph planner, a grid-based shortest path planner, A*, D*, or any combination thereof. The environment of the method includes holes corresponding to obstacle regions entirely surrounded by free-space cells.

According to the disclosure, the coverage path of the method is a closed tour that returns to a start cell. The coverage path of the method is an open path having distinct start and end positions.

According to the disclosure, the coverage path length of the method is bounded, in a worst case, by a constant factor relative to an optimal coverage path length for the grid representation. The mobile robot further comprises a cleaning robot and the tool footprint corresponds to a cleaning footprint.

According to the disclosure, a robotic coverage planning system comprises a mobile robot comprising a drive system and a coverage tool, and one or more processors coupled to memory and configured to execute instructions that cause the system to determine ranks covering a connected set of free-space cells of a grid representation of an environment, compute a minimum-length perfect matching among rank endpoints using collision-free transition costs, form subtours from the ranks and matched transitions, merge adjacent subtours into a single coverage path using at least one of (i) a double-edge merge between neighboring cells and (ii) a corner-junction edge swap merge and command the mobile robot to traverse the coverage path.

According to the disclosure, the processors of the system are configured to select a spanning tree of a subtour adjacency graph to order merges. The processors of the system are configured to compute a minimum spanning tree weighted by turns added by candidate merges.

According to the disclosure, the processors of the system are configured to select the corner-junction edge-swap merge when it adds no additional path length beyond reuse of rank segments. The processors are configured to modify a subtour to induce an edge at a corner junction prior to performing the edge-swap merge.

According to the disclosure, the processors of the system are configured to apply a length threshold such that merges predicted to add more than about 2l length are performed using the double-edge merge. The processors of the system are configured to perform lazy evaluation of collision-free transition costs by initially using lower-bound costs and computing collision-free paths for only edges appearing in an intermediate matching.

According to the disclosure, the processors of the system iteratively update costs for edges in the intermediate matching until the matching comprises collision-free edges. The grid representation of the system comprises square cells whose width corresponds to a tool width.

According to the disclosure, a non-transitory computer-readable medium storing instructions that, when executed by one or more processors, cause the one or more processors to perform operations comprising generating ranks that cover free-space cells of a grid representation of an environment, computing a minimum-length perfect matching among endpoints of the ranks using collision-free transition path lengths, forming subtours from the ranks and matched transitions, determining adjacency between subtours and selecting a spanning tree to order merges, merging adjacent subtours using at least one of: (i) a double-edge merge and (ii) a corner-junction edge-swap merge with optional subtour modification, and outputting a coverage path for a robot to traverse.

According to the disclosure, the instructions of the medium further cause the processors to select a minimum spanning tree based on turn-addition weights. The instructions further cause the processors to select between merge strategies based on predicted added length.

According to the disclosure, the instructions further cause the processors to compute collision-free transition lengths using a grid shortest-path algorithm. The instructions further cause the processors to compute collision-free transition lengths using a visibility graph.

According to the disclosure, the output coverage path of the medium is a closed tour. The instructions of the medium further cause the processors to minimize turns per unit length as a secondary objective.

According to the disclosure, the instructions of the medium further cause the processors to perform lazy evaluation of transition costs starting from Euclidean lower bounds. The environment comprises of the medium one or more obstacle holes.

According to the disclosure, each cell of the medium corresponds to a square tool footprint. The coverage path length of the medium is bounded in a worst case by a constant factor relative to an optimal coverage path length for the grid representation.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Portions of this application, including the specification and / or claims, may have been drafted using AI-assisted tools under the direction and supervision of a human practitioner. All inventive contributions are attributable to the listed inventors.

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented method for generating a coverage path for a robot in a grid environment, the method comprising:
computing, by one or more processors, a rank partition of free cells of the grid environment into a plurality of axis-parallel ranks, each rank comprising contiguous free cells coverable by a straight-line sweep of a coverage tool;
generating a set of coverage lines, each coverage line corresponding to a respective rank and spanning endpoints of the respective rank;
forming a transition graph whose vertices comprise endpoints of the coverage lines and whose edges comprise feasible collision-free transition paths between endpoints with associated edge costs;
computing, on the transition graph, a minimum-length perfect matching that pairs endpoints of the coverage lines;
combining the coverage lines and the minimum-length perfect matching to form a plurality of closed sub-tours that collectively cover the free cells; and
merging the plurality of closed sub-tours into a single closed coverage tour by repeatedly applying, for selected adjacent sub-tour pairs, a merge operation chosen to limit added path length.

2. The method of claim 1, wherein computing the rank partition comprises computing a minimum-rank partition that minimizes a number of ranks among axis-parallel rank partitions of the free cells.

3. The method of claim 1, wherein the selected adjacent sub-tour pairs are determined by constructing a sub-tour adjacency graph in which vertices represent sub-tours and edges connect adjacent sub-tours, and selecting edges of a spanning tree of the sub-tour adjacency graph.

4. The method of claim 3, wherein the sub-tour adjacency graph comprises edge weights representing an estimated number of turns added by merging the corresponding adjacent sub-tours, and wherein the spanning tree is a minimum spanning tree that reduces the estimated number of added turns.

5. The method of claim 1, wherein the merge operation comprises a double-edge merge that adds a traversal from a cell covered by a first sub-tour to an adjacent cell covered by a second sub-tour and adds a return traversal from the adjacent cell to the cell.

6. The method of claim 1, wherein the merge operation comprises a corner-junction merge at a corner junction formed by four cells including two adjacent cells covered by a first sub-tour that share a corner with two adjacent cells covered by a second sub-tour, the corner-junction merge comprising performing an edge swap that replaces two edges in the sub-tours with two cross edges that connect the sub-tours.

7. The method of claim 6, further comprising, when a required junction edge is absent from at least one of the sub-tours, modifying the at least one sub-tour by removing a first set of edges and adding a second set of edges to create the required junction edge, and thereafter performing the edge swap.

8. The method of claim 7, wherein the modifying is selected based on a length bound for an added cross path and, when the length bound is not satisfied, the merge operation is instead performed as a double-edge merge.

9. The method of claim 1, further comprising selecting, among a plurality of candidate merge locations between a first sub-tour and a second sub-tour, a location that minimizes added turns subject to limiting added length.

10. The method of claim 1, wherein the grid environment is connected and includes at least one obstacle or hole, and wherein the coverage tool has a footprint width approximately equal to a grid cell width.

11. The method of claim 1, wherein the transition graph edge costs satisfy a triangle inequality.

12. The method of claim 1, wherein computing the minimum-length perfect matching comprises a lazy evaluation process including the steps of:
initializing a dense endpoint graph with edges weighted by Euclidean distances between endpoints;
computing a candidate perfect matching on the dense endpoint graph;
for each edge in the candidate perfect matching, determining whether the corresponding Euclidean edge is collision-free; and
replacing each Euclidean edge that is not collision-free with a computed collision-free path edge having an updated edge cost and recomputing the candidate perfect matching until the candidate perfect matching contains only collision-free path edges.

13. The method of claim 1, wherein the single closed coverage tour has a total length that is bounded by an approximation factor relative to an optimal coverage tour for the free cells.

14. A robotic coverage planning system comprising:
a mobile robot comprising a drive system and a coverage tool; and
one or more processors coupled to memory and configured to execute instructions that cause the system to:
determine ranks covering a connected set of free-space cells of a grid representation of an environment;
compute a minimum-length perfect matching among rank endpoints using collision-free transition costs;
form subtours from the ranks and matched transitions;
merge adjacent subtours into a single coverage path using at least one of (i) a double-edge merge between neighboring cells and (ii) a corner-junction edge-swap merge; and
command the mobile robot to traverse the coverage path.

15. The system of claim 14, wherein the processors are configured to select a spanning tree of a subtour adjacency graph to order merges.

16. The system of claim 14, wherein the processors are configured to compute a minimum spanning tree weighted by turns added by candidate merges.

17. The system of claim 14, wherein the processors are configured to select the corner-junction edge-swap merge when it adds no additional path length beyond reuse of rank segments.

18. The system of claim 14, wherein the processors are configured to modify a subtour to induce an edge at a corner junction prior to performing the edge-swap merge.

19. The system of claim 14, wherein the processors are configured to apply a length threshold such that merges predicted to add more than about 2l length are performed using the double-edge merge.

20. The system of claim 14, wherein the processors are configured to perform lazy evaluation of collision-free transition costs by initially using lower-bound costs and computing collision-free paths for only edges appearing in an intermediate matching.
